(19) United States
(12) Patent Application Publication
(10) Pub. No.: US 2025/0158690 A1
(43) Pub. Date: May 15, 2025

(54) SYSTEMS AND METHODS FOR IDENTIFYING BEAMS FOR FORWARDING LINKS

(71) Applicant: ZTE CORPORATION, Shenzhen (CN)

(72) Inventors: Shuang ZHENG, Shenzhen (CN); Nan ZHANG, Shenzhen (CN); Wei CAO, Shenzhen (CN); Hanqing XU, Shenzhen (CN); Ziyang LI, Shenzhen (CN)

(73) Assignee: ZTE CORPORATION, Shenzhen (CN)

(21) Appl. No.: 19/024,587

(22) Filed: Jan. 16, 2025

Related U.S. Application Data
(63) Continuation of application No. PCT/CN2022/122419, filed on Sep. 29, 2022.

(51) Int. Cl. H04B 7/06

(52) U.S. Cl. CPC H04B 7/06952

(57) ABSTRACT

Presented are systems and methods for identifying beams for forwarding links. A network node may receive beam indication used for at least one of a first forwarding link or a second forwarding link from a wireless communication node. The first forwarding link can be between a wireless communication device and the network node. The second forwarding link can be between the wireless communication node and the network node.

### CROSS-REFERENCE TO RELATED APPLICATION

This application claims the benefit of priority under 35 U.S.C. § 120 as a continuation of PCT Patent Application No. PCT/CN2022/122419, filed on Sep. 29, 2022, the disclosure of which is incorporated herein by reference in its entirety.

### TECHNICAL FIELD

The disclosure relates generally to wireless communications, including but not limited to systems and methods for identifying beams for forwarding links.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments (e.g., including combining features from various disclosed examples, embodiments and/or implementations) can be made while remaining within the scope of this disclosure.

At least one aspect is directed to a system, method, apparatus, or a computer-readable medium of the following. A network node may receive beam indication used for at least one of a first forwarding link or a second forwarding link from a wireless communication node. The first forwarding link can be between a wireless communication device and the network node. The second forwarding link can be between the wireless communication node and the network node. The beam indication may include one or a plurality of beams.

In some embodiments, the wireless communication node may receive the capability information of network node from the network node or an operations administration and maintenance (OAM) unit. The capability information may include at least one of the following: relationships between different types of beams of the network node; a number of beams for simultaneous operation; a number of panels of the network node; a number of panels for simultaneous operation; a number of frequency resource supported on the network node; or a number of frequency resource for simultaneous operation.

In some embodiments, the network node may receive first beam indication including a list of beam patterns from the wireless communication node. Each beam pattern may include one or a plurality of ordered beams to be used one by one and may have a beam pattern index for the list. The network node may receive second beam indication including one or more beam pattern indices from the wireless communication node. The beam can be associated with one of a beam index, a source Reference Signal (RS) identification, or a Transmission Configuration Indicator (TCI) state identification.

In some embodiments, the indices or identities of beams on the first forwarding link of the different network node can be numbered using different numbering methods. The numbering methods can be associated with a capability of the network node.

A signaling of beam indication can be indicated via at least one of a Radio Resource Control (RRC) signaling, a medium access control control element (MAC CE) signaling, or a Downlink Control Information (DCI) signaling.

In some embodiments, the network node may receive information indication associated with the beam indication from the wireless communication node. The information indication may include at least one of: respective time resource information associated with the one or plurality of beams; respective frequency resource information associated with the one or plurality of beams; or respective panel information associated with the one or plurality of beams. The frequency resource information can be associated with one of a carrier index, a passband index, or a Bandwidth Part (BWP) index. The respective frequency resource information may include a sequence of indices for frequency resources. Each of the frequency resource can be associated with a beam indicated in the beam indication.

In some embodiments, the respective frequency resource information may include a sequence of index for frequency resource. Each of the frequency resource can be associated with the plurality of beams indicated in the beam indication. The respective frequency resource information may include a single index for a single frequency resource. The single frequency resource can be associated with all beams indicated in the beam indication. The respective panel information may include a sequence of index for panel information. Each of panel information can be associated with a beam indicated in the beam indication. The respective panel information may include a sequence of index for panel information. Each of panel information can be associated with the plurality of beams indicated in the beam indication. The respective panel information may include a single index for panel information. The single panel information can be associated with all beams indicated in the beam indication. The signaling of the information indication can be at least one of a Radio Resource Control (RRC) signaling, a medium access control control element (MAC CE) signaling, or a Downlink Control Information (DCI) signaling.

In some embodiments, the DCI may have a first DCI format and a second DCI format. The first DCI can be scrambled with a first Radio Network Temporary Identifier (RNTI). The first DCI can be used for the control link between the network node and the wireless communication node. The second DCI can be scrambled with a second Radio Network Temporary Identifier (RNTI). The second DCI can be used for the first forwarding link.

In some embodiments, one of existing bits in a MAC CE signaling can be configured to indicate activated TCI states in the MAC CE that are configured for the second forwarding link or a control link between the network node and the wireless communication node. A new bit in a MAC CE signaling can be configured to indicate activated TCI states in the MAC CE that are configured for the second forwarding link or a control link between the network node and the wireless communication node. One or a plurality of bits in the MAC CE signaling can be used to indicate time domain information associated with the activated TCI states. One or a plurality of bits in the MAC CE signaling can be used to indicate frequency domain information associated with the activated TCI states. One or a plurality of bits in the MAC CE signaling can be used to simultaneously indicate time domain information and frequency domain information associated with the activated TCI states. A first part of bits can be used to indicate the time domain information and a second part of bits can be used to indicate the frequency domain information.

In some embodiments, a pair of TCI states can be activated in a MAC CE signaling. A first TCI state in the activated pair of TCI states can be used for the beam indication of second forwarding link. A second TCI state in the activated pair of TCI states can be used for the beam indication of a control link between the network node and the wireless communication node. One of existing bits in a DCI signaling can be used to indicate selected TCI states that are used for the second forwarding link or a control link between the network node and the wireless communication node.

In some embodiments, one of existing bits in a DCI signaling can be used to indicate one or more TCI states selected from a first MAC CE signaling or a second MAC CE signaling. The first MAC CE signaling can be used to activate the one or more TCI states for the second forwarding link. The second MAC CE signaling can be used to activate the one or more TCI states for a control link between the network node and wireless communication node. A new bit in a DCI signaling can be used to indicate selected TCI states that are used for the second forwarding link or a control link between the network node and the wireless communication node. A new bit in a DCI signaling can be used to indicate one or more TCI states selected from a first set of TCI states activated by a first MAC CE signaling or from a second set of TCI states activated by a second MAC CE signaling. The first MAC CE signaling can be used to activate the one or more TCI states for the second forwarding link. The second MAC CE signaling can be used to activate the one or more TCI states for a control link between the network node and wireless communication node. In some embodiments, the network node may receive a number of TCI states that are used for the second forwarding link from the wireless communication node.

In some embodiments, a wireless communication node may transmit beam indication used for at least one of a first forwarding link or a second forwarding link to a network node. The first forwarding link can be between a wireless communication device and the network node. The second forwarding link can be between the wireless communication node and the network node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example network controlled repeater (NCR), in accordance with some embodiments of the present disclosure;

FIG. 4 illustrates an example for identifying beams for forwarding links, in accordance with some embodiments of the present disclosure;

FIG. 5 illustrates an example for considering time and frequency information for beam indication, in accordance with some embodiments of the present disclosure;

FIG. 6 illustrates an example for considering time, frequency, and panel information for beam indication, in accordance with some embodiments of the present disclosure;

FIG. 7 illustrates an example for considering time, frequency, and panel information for multiple beam pattern indication, in accordance with some embodiments of the present disclosure;

FIG. 8 illustrates an example for transmission configuration indicator (TCI) state indication, in accordance with some embodiments of the present disclosure;

FIG. 9 illustrates an example for transmission configuration indicator (TCI) state indication, in accordance with some embodiments of the present disclosure;

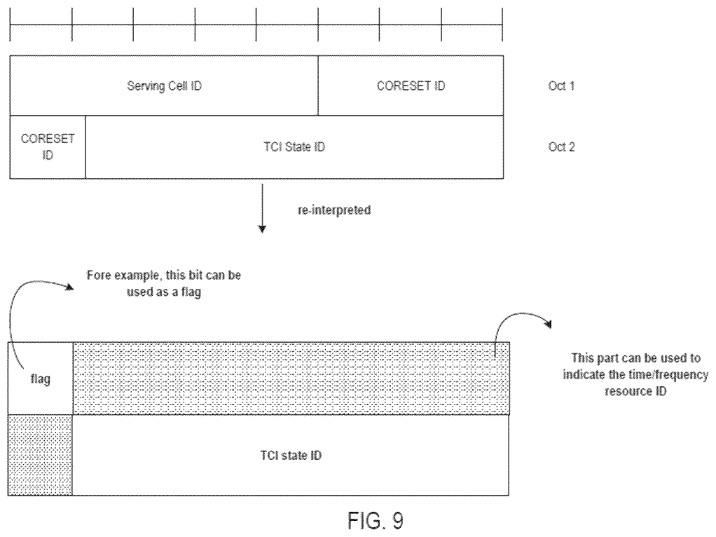

FIG. 10 illustrates an example for transmission configuration indicator (TCI) state indication, in accordance with some embodiments of the present disclosure;

FIG. 11 illustrates an example for transmission configuration indicator (TCI) state indication, in accordance with some embodiments of the present disclosure;

FIG. 12 illustrates an example for transmission configuration indicator (TCI) state indication, in accordance with some embodiments of the present disclosure;

FIG. 13 illustrates an example for transmission configuration indicator (TCI) state indication, in accordance with some embodiments of the present disclosure;

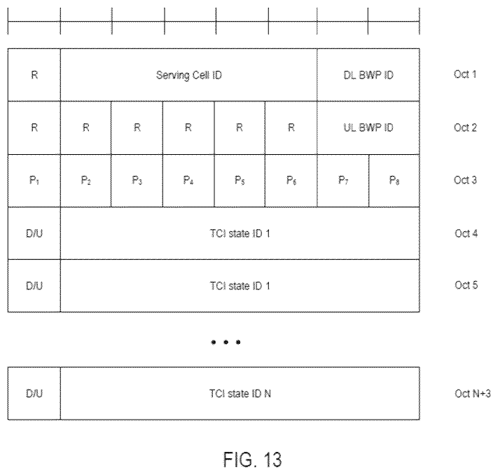

FIG. 14 illustrates an example beam type on access link, in accordance with some embodiments of the present disclosure; and

FIG. 15 illustrates a flow diagram for identifying beams for forwarding links, in accordance with an embodiment of the present disclosure.

### DETAILED DESCRIPTION

### 1. Mobile Communication Technology and Environment

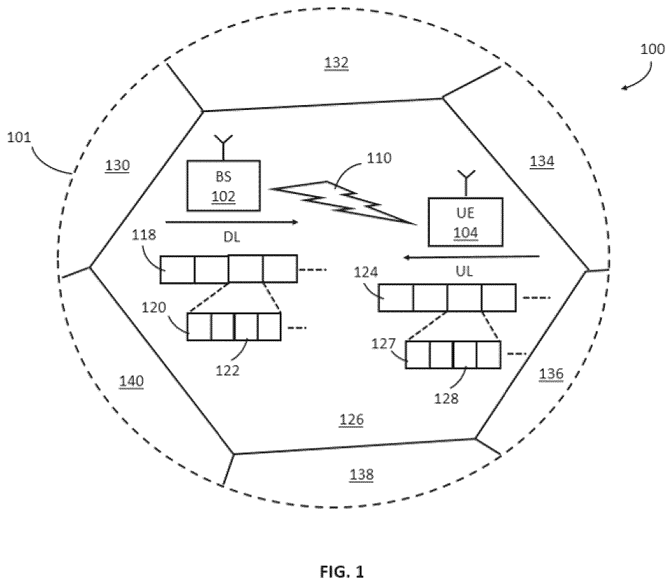

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

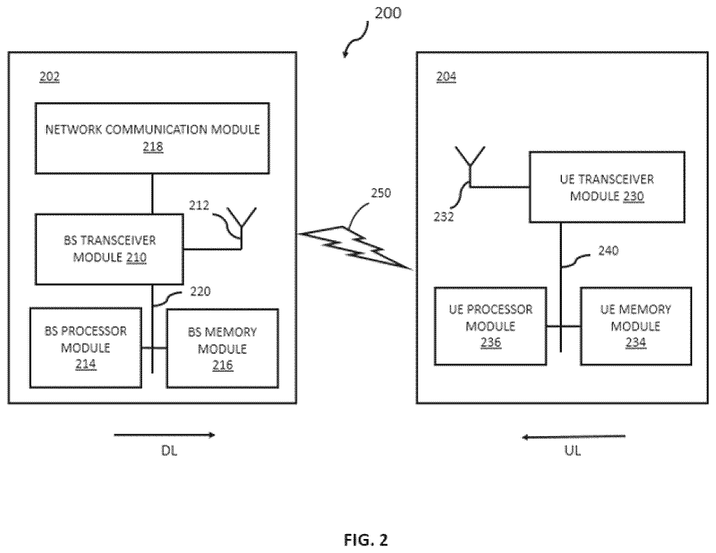

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Identifying Beams for Forwarding Links

As the new radio (NR) system moves to higher frequencies (around 4 GHz for FR 1 deployments and above 24 GHz for FR 2), propagation conditions may degrade compared to lower frequencies, which exacerbates coverage challenges. As a result, further densification of cells may be one solution. While a deployment of regular full-stack cells is preferred, it may not be an economically viable option. To provide blanket coverage in cellular network deployments with relatively low cost, radio frequency (RF) repeaters with full-duplex amplify-and-forward operation may use in 2G, 3G, and/or 4G systems. However, a major problem brought by the RF repeater can be that the RF repeater amplifies both signal and noise, and may increase interference in the system.

Another property of the NR systems can be the use of multi-beam operation with associated beam management in the higher frequency bands defined for time division duplex (TDD). The multi-antenna techniques including massive multiple-input multiple-output (MIMO) for FR1 and analog beamforming for FR2 assist in coping with the challenging propagation conditions of these higher frequency bands. The RF repeater without beam management functions may not provide beamforming gain in its signal forwarding.

To cope with the unwanted interference, a network controlled repeater can be considered, which makes use of a control information from its connected BS to enable an intelligent amplify-and-forward operation. In this disclosure, a method for beam information indication is investigated for a cellular network with smart nodes.

RF repeaters may be used in 2G, 3G and/or 4G deployments to supplement the coverage provided by regular full-stack cells with various transmission power characteristics. The RF repeaters may provide a simple and cost-effective way to improve network coverage. The main advantages of RF repeaters can be their low-cost, their case of deployment, and the fact that the RF repeaters do not increase latency. The main disadvantage can be that the RF repeaters amplify signal and noise. Hence, the RF repeaters may contribute to an increase of interference (e.g., pollution) in the system. Within the RF repeaters, there can be different categories depending on power characteristics and an amount of spectrum that the RF repeaters are configured to amplify (e.g., single band or multi-band). The RF repeaters can be non-regenerative type of relay nodes. The RF repeaters may simply amplify-and-forward signal in an omnidirectional way.

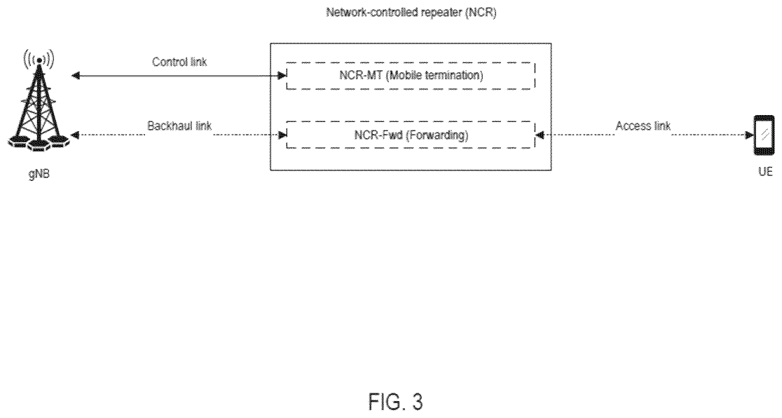

From perspective of functionality, a structure of network controlled repeater (NCR) is illustrated in FIG. 3. The NCR-mobile termination (MT) is defined as a function entity to communicate with a gNB via a control link (C-link) to enable exchange of control information (e.g., side control information at least for a control of NCR-Fwd). The C-link is based on NR Uu interface. The NCR-forwarding (Fwd) is defined as a function entity to perform the amplify-and-forwarding of uplink/downlink (UL/DL) RF signal between a gNB and a UE via a backhaul link and an access link. The behavior of the NCR-Fwd may be controlled according to received side control information from the gNB.

### Implementation Example 1: Beam Information Indication for Access Link

A base station (BS) can indicate beam information to a network controlled repeater (NCR). The NCR may forward the signal using corresponding beam. Following options can be considered for beam indication:

Option 1 (per beam indication): the BS can send an indication of beam information to the NCR. The indication of beam information can be a beam index, a source reference signal (RS) identity (ID) or a transmission configuration indicator (TCI) state ID. In addition to the above beam information (e.g., which beam may be used to forward the signal), the NCR may also receive one or more following information (e.g., when and where to forward the signal) associated with the indicated beam information from the BS. (i) Timing domain resource information: the timing domain resource may include a time domain granularity, a start time, a valid duration, and/or a period of valid duration. (ii) Frequency resource information: the frequency domain resource can be a carrier index, a passband index, or a bandwidth part (BWP) index. (iii) Panel information: the panel information may indicate which panel can be used on an access link if the NCR has multiple panels on access links.

Option 2 (per beam pattern indication): the BS can send an indication of beam information using a beam pattern format to the NCR. The beam pattern format can be an ordered sequence of the NCR's beam. The beams in each beam pattern can be same or different. If all beams in a beam pattern is same, it may indicate the beam pattern includes only one beam. The beam information of each beam in the beam pattern can be a beam index, a source RS ID, or a TCI state ID. Following methods can be considered for the BS to indicate the beam information. Op 2.1: the BS can directly indicate one or more beam patterns (e.g., ordered sequence of the NCR's beam). Op 2.2: the BS can firstly configure an applicable beam list including one or more beam patterns. Each beam pattern in the list may have a corresponding index. The beams in the each beam pattern can be same or different. If all beams in a beam pattern is same, it may indicate this beam pattern includes only one beam. In such case, when the BS wants to indicate the beam information to the NCR, the BS can directly indicate one or more beam pattern indices configured in the applicable beam list to the NCR.

For each beam pattern, the BS can also indicate the applicable time, frequency, and/or panel information to the NCR. The indication can include one or more following information.

Time resource information: One or more time lengths can be applicable for each indicated beam in the beam pattern. The one or more time lengths can be different or partly same. A relationship between the indicated time length and the beams can be at least one of following. (i) One-to-one mapping: each time length can be applicable to each beam in the beam pattern. (ii) One-to-multiple mapping: each time length can be applicable to multiple beams in the beam pattern. In this case, the number of applicable beams for each time length can be indicated to the NCR. If the number of applicable beams for each time length is same, the BS can only indicate a default number of applicable beams which can be used to all indicated time length. (iii) One-to-all mapping: one time length can be applicable for all indicated beams in the beam pattern.

The granularity of time length can be a symbol level or a slot level. In addition, a valid time interval for the indicated beam pattern may be indicated to the NCR. A valid time interval can be: (i) a start time+a time length; (ii) a start time+an end time; and/or (iii) a predefined timer index.

Frequency resource information: One or more frequency resource information can be applicable for each indicated beam in the beam pattern. The indicated plurality of frequency resource information can be different or partly same. The frequency resource information can be a carrier index, a passband index, and/or a BWP index. A relationship between the indicated frequency resource information and the indicated beam can be at least one of following. (i) One-to-one mapping: each frequency resource information can be applicable to each indicated beam in the beam pattern. (ii) One-to-multiple mapping: each frequency resource information can be applicable to multiple beams in the beam pattern. In this case, the number of applicable beams for each frequency resource information may be indicated to the NCR. If the number of applicable beams for each frequency resource information is same, the BS can only indicate a default number of applicable beams which can be used to all indicated frequency resource information. (iii) One-to-all mapping: one frequency information can be applicable for all indicated beams in the beam pattern.

Panel information: One or more panel information to be configured for each indicated beam in the beam pattern. After receiving the panel information, the NCR can be notified a corresponding panel that may be used to forward the signal using the indicated beam. The indicated panel information can be the panel index of the NCR. A relationship between the panel information and the indicated beam information can be at least one of following. (i) One-to-one mapping: each panel information can be applicable to each indicated beam in the beam pattern. (ii) One-to-multiple mapping: each panel information can be applicable to multiple beams in the beam pattern. In this case, the number of applicable beams for each panel information may be indicated to the NCR. If the number of applicable beams for each panel information is same, the BS can only indicate a default number of applicable beams which can be used to all indicated panel information. (iii) One-to-all mapping: one panel information can be applicable for all indicated beams in the beam pattern.

The beam information, the associated time resource information, the frequency resource information, and the panel information can be configured or be indicated by at least one of: a radio resource control (RRC) signaling, a medium access control control element (MAC CE) signaling, or a downlink control information (DCI) signaling. The beam information and the associated time resource information can be indicated or configured in the same signaling or different signaling. The beam information and the associated frequency resource information can be indicated or configured in the same signaling or different signaling. The beam information and the associated panel information can be indicated or configured in the same signaling or different signaling. Moreover, the indicated beam can be the available beam of NCR on access link or the beam used on the access link by the NCR.

Multiple beam pattern indexes can be configured via a RRC for different common signal forwarding. A DCI can be used to indicate one of the beam index patterns, e.g., using a pattern index. The corresponding time/frequency domain resource can be included in the DCI. For example, a fixed time length, a sequence of time start, or a fixed frequency resource assignment can be used for voice over new radio (VoNR) service of multiple UEs.

Compared with DCI formats for normal UEs, required fields for an NCR can be relatively simple. Therefore it is possible to define a new DCI format with a separate radio network temporary identifier (RNTI) for the NCR-Fwd. In other words, each NCR may have two RNTIs, one for NCR-MT and the other for NCR-Fwd. The new DCI format for the NCR-Fwd may have a cyclic redundancy check (CRC) scrambled by the NCR-Fwd's RNTI. The NCR may monitor PDCCH for both NCR-MT and NCR-Fwd, and may blindly decode the received PDCCH using two RNTIs to determine that the DCI is for NCR-MT or NCR-Fwd.

Different NCRs may have different type of beams, for example, the NCR 1 only has the wide beams, while the NCR 2 has both wide beams and narrow beams. In this case, after receiving the capability information of NCR, the BS can use different beam numbering methods to the different NCR according to NCR's capability. In some embodiments, the different beam numbering methods can be pre-defined to the NCR, and in some embodiments the different beam numbering method can be indicated to the NCR by the BS. For example, the NCR 1 reports to the BS that it only has 4 wide beams, the NCR 2 reports to the BS that it has 2 wide beams and 4 narrow beams. In this case, the BS can use different beam numbering method. For the beam of NCR 1, the BS may configure the beam indexes 0˜3 for the NCR1, and 2 bits can be used to indicate the beam information of NCR 1. For the beam of NCR 2, the BS may configure indexes 0˜3 for the narrow beams and indexes 0˜1 for the wide beams. An extra bit can be used as the beam width flag, with 0 referring to the narrow beams and I referring to the wide beams. For narrow beam indication of NCR 2, 3 bits (one bit as a flag and two bits for the index of narrow beam) can be used. For wide beam indication of NCR 2, 2 bits (one bit as a flag and one bit for index of wide beam) can be used.

When the NCR has different types of beams, the beams of NCR can be divided into different beam groups. Each beam group may include only one first type of beam (e.g., a wide beam) and multiple second type of beams (e.g., narrow beams). A special case can be that the beams of NCR can only be divided into one beam group. The capability information may include at least one or more following information: the number of beams, the relationship between different type of beams, and the grouping information of beams, which can be reported to the BS by the NCR or directly configured to the BS by the OAM. After receiving this beamforming capability information, the BS can indicate the applicable beams that can be used on the access link to the NCR. In some embodiments, the BS can also indicate to the NCR the beams that cannot be used on the access link. If the BS indicates to the NCR that only one beam group can be used on the access link, or the beams of NCR can only be divided into one beam group, the BS can directly indicate the index of second type of beams to the NCR. If the BS does not indicate any beam information to the NCR, it may implicitly indicate that the NCR uses the first type of beam to forward the signal on access link. For example, the NCR may have two beam group. The group 0 may have a wide beam and 4 narrow beams. The group 1 may have a wide beam and 4 narrow beams. This beamforming information can be reported to the BS by the NCR. The BS can indicate to the NCR that only beams in group 0 can be used on access link. In this case, when indicating the beam information to the NCR, the BS can directly use 2 bits to indicate the index of narrow beams in group 0. If the BS does not indicate any beam information to the NCR, it may implicitly mean that the NCR uses the wide beam in group 1 to forward the signal on access link.

When the NCR has different types of beams, the beams of NCR can be divided into different beam groups. Each beam group may include only one first type of beam (e.g., a wide beam) and multiple second type of beams (e.g., narrow beams). In this case, a group numbering method can be used to number the beams of NCR. The different group can be numbered with the corresponding index, and the multiple second type of beams in each group can be numbered with the corresponding index. There can be no need to number the first type of beam in each group since the group index can implicitly indicate the index of wide beam. When indicating the beam information, the BS can directly use one or more bits to indicate the index of group, and may use one or more bits to indicate the index of second type of beams in the corresponding group. For example, the NCR may have two beam groups. The two groups can be numbered with index 0˜1, respectively. The group 0 has a wide beam and 4 narrow beams, where the 4 narrow beams can be numbered with index 0˜3, respectively. The group 1 may have a wide beam and 4 narrow beams, where the 4 narrow beams can be numbered with index 0˜3, respectively. In this case, when indicating the beam information to the NCR, the BS can directly use one bit as a flag to indicate the group index, and may use two bits to indicate the index of second type of beams in the corresponding beam. In some embodiments, the BS may indicate to the NCR that only one beam group can be used by the NCR, or the beams of NCR can only be divided into one beam group. In this case, when indicating the beam information to the NCR, the BS can directly indicate the index of narrow beams in the applicable beam group, and there can be no need to use a bit to indicate the index of group.

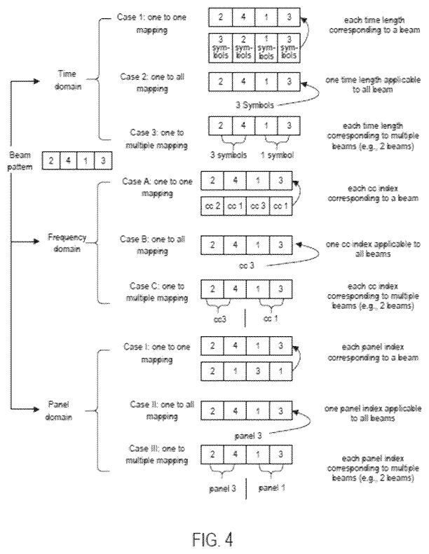

All possible cases for the time resource, the frequency resource and the panel information indication for the indicated beams are illustrated in FIG. 4. Different cases of different resource information can be combined to indicate the corresponding time resource, the corresponding frequency resource, and the corresponding panel information with the associated beam information.

In order to provide more illustrations for combination cases of time, frequency, and panel information with the associated beam information, following examples are given.

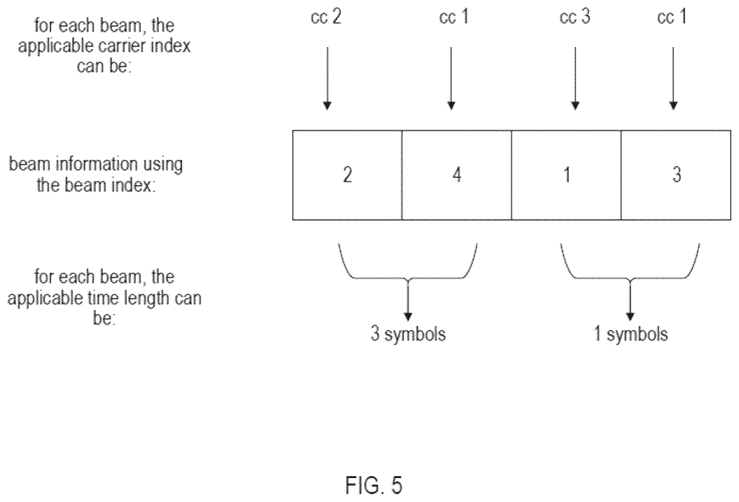

Example 1: The BS can indicate an ordered sequence of beams using the beam index (e.g., beam index 2413) to the NCR. Each beam in the beam pattern may have the applicable time and frequency resource. For example as shown in FIG. 5, the beam index 2, 4, 1, 3 may be used in the corresponding carrier 2, 1, 3, 1, respectively. The applicable time length of the beam 2 and 4 can be 3 symbols. The applicable time length of beam 1 and 3 can be 1 symbol. The valid time interval (e.g., the start time and the time length) for this beam indication may be indicated to the NCR. After receiving the information, the NCR can forward the signal using the corresponding beam in the corresponding carrier and time. All the beam information and the corresponding time and frequency information can be configured in a RRC signaling, and can be indicated to the NCR. The RRC reconfiguration can be used to update the corresponding beam and/or associated time and frequency information.

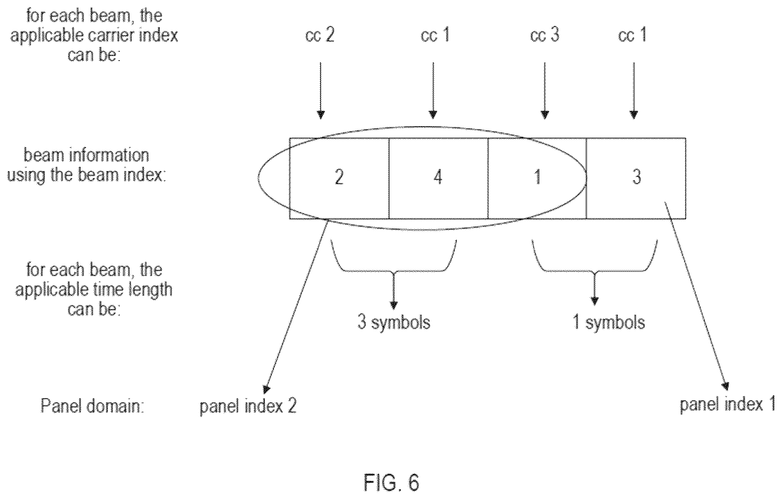

Example 2: Considering that the NCR has multiple panels, the BS can indicate the corresponding panel information to the NCR for the indicated beam information. For example, in addition to the frequency domain and time domain information in the example 1, the BS may indicate that the first three beams in the indicated beam pattern can be applicable for the panel index 2, and the panel index 1 can be configured for the beam index 3, as shown in FIG. 6.

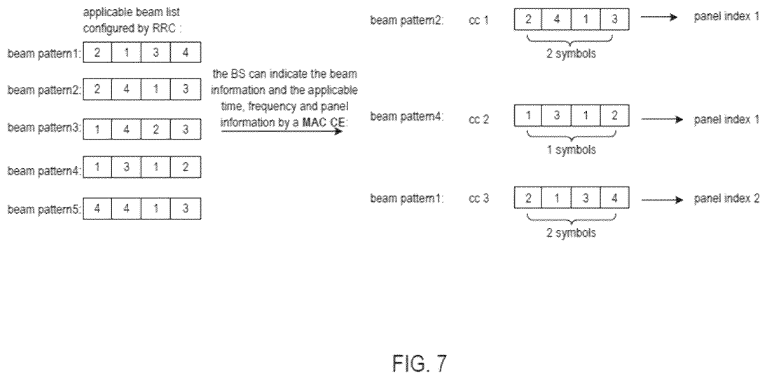

Example 3: The BS can firstly configure an applicable beam list in a RRC signaling. The applicable beam list may include one or more beam patterns. Each beam pattern may have a corresponding index. For each beam in each beam pattern, each beam can have different time information, frequency information, and/or panel information. For each beam pattern in the beam pattern list, each beam pattern can have different applicable times and frequency information. For example, the BS can use a MAC CE to indicate one or more beam pattern indices (e.g., the beam pattern index 2, 4, 1 in FIG. 7) and the corresponding applicable time, frequency and panel information for each indicated beam pattern to the NCR. As shown in FIG. 7, as for the beam pattern 2, 4, 1, the corresponding applicable carrier can be carrier 1, 2, 3 respectively, the applicable panel index can be panel 1, 1, 2 respectively, and the applicable time length can be 2, 1, 2 symbols respectively. After receiving the MAC CE, the NCR can be notified how to forward the signal in the corresponding beam and panel under the corresponding time and frequency resource.

### Implementation Example 2: Beam Indication for Backhaul Link

A transmission configuration indicator (TCI) framework to indicate beam information can be considered for a backhaul link. Since the TCI states are used to indicate the beam information for communication links with a possibility that different TCI states are configured for the communication links and the backhaul links, some refinements and enhancements for the TCI state framework may be considered with following options.

In Step 1: A RRC configuration for the TCI state/spatial relation can be considered as follows. Op 1.1: The TCI state configuration for the communication links can be re-configured for the backhaul links. Op 1.2: A new TCI state configuration can be defined for the backhaul link. Op 1.3: Additional RRC configuration of spatial relation for the backhaul link.

In Step 2: A MAC CE to activate or select the TCI states for the backhaul link can be considered as follows. Op 2.1: A new MAC CE can be defined to activate/deactivate one or more TCI states for the backhaul (BH) link.

Op 2.2: One of a bit in the MAC CE can be used as a flag to indicate that the activated TCI states/spatial relation in the MAC CE is for C-link or BH link. More specifically, the bit can be at least one of: (a) One of a bit can be re-interpreted or reused as a flag to indicate that the MAC CE is for C-link or BH link. For example, if this bit flag is set as 1, it may indicate that the MAC CE is used to activate/deactivate or select one or more TCI states/spatial relation for backhaul link. If this bit flag is set as 0, it may indicate that this MAC CE is configured for C-link. (b) A new bit can be added in the MAC CE as a flag to indicate this MAC CE is for C-link or BH link. For example, if this new bit flag is set as 1, it may indicate that this MAC CE is used to activate/deactivate or select one or more TCI states/spatial relations for backhaul link. If this new bit flag is set as 0, it may indicate that this MAC CE is configured for C-link.

Moreover, one or more bits in the MAC CE can be re-interpreted or reused to indicate the time and/or frequency information. More specifically, the one or more bits can be at least one of: (a) The one or more bits can be used to indicate the time resource information applicable for the beam corresponding to the selected TCI state in the MAC CE. (b) The one or more bits can be used to indicate the frequency resource information applicable for the beam corresponding to the selected TCI state in the MAC CE. (c) The one or more bits can be used to simultaneously indicate the time and frequency information applicable for the beam corresponding to the selected TCI state in the MAC CE. One or a part of the one or more bits can be configured for the time resource information. One or the other part of remaining bits can be configured for the frequency resource information.

Op 2.3: if a MAC CE is used to map one or more pairs of TCI states to the code point of the TCI field in the DCI. Each pair of TCI state can be re-interpreted as one TCI state for C-link and one TCI state for backhaul link.

Following examples are given to provide further illustrations on the Op 2.2.

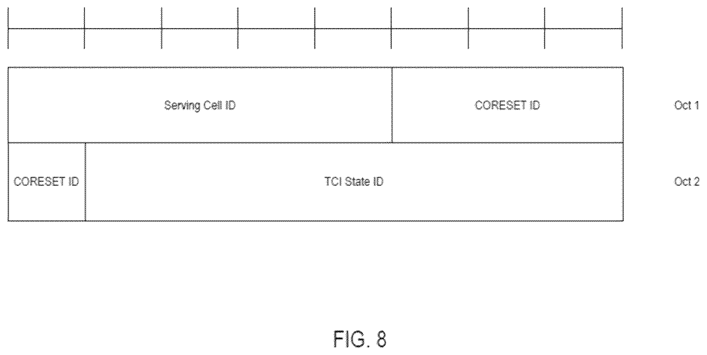

Example 1: The TCI state indication for UE-specific physical downlink control channel (PDCCH) MAC CE can be reused with some refinements for the backhaul links. The TCI state indication for UE-specific PDCCH MAC CE may have a fixed size with fields in FIG. 8. Although the controller of the smart node has the similar functionality with the normal UE, the smart node may have a fixed serving cell once integrated to the network. There may be no indication on the serving cell ID for the smart node. In such case, the “Serving Cell ID” field in the MAC CE can be re-interpreted if the MAC CE is indicated to the smart node. One of bits in the Serving Cell field ID can be acted as a flag (e.g., the first bit in the Oct 1 as shown in FIG. 8) to indicate that the MAC CE is used to select the TCI state ID for communication links or backhaul links. If the bit is 1, it may indicate that this MAC CE is configured for the backhaul links. If the bit is 0, it may indicate that this MAC CE is configured for the communication links. If the MAC CE is for the backhaul links, the remaining bits in the “Serving Cell ID” field and the “CORESET ID” field in the MAC CE can be used together to indicate the time and/or frequency information. In this case, the BS can firstly configure a list of time domain resource list and/or a list of frequency domain resource list configured for the backhaul link in the RRC signaling to the smart nodes.

Following options can be considered for the use of remaining bits in the MAC CE. (a) The remaining bits can be used to indicate the time resource ID applicable for the beam corresponding to the selected TCI state. The remaining bits can be totally used or partly used. If the remaining bits are partly used, the unused bits of Oct 1 can be directly set as reserved. For example, if the BS wants to indicate the corresponding time resource ID 3 in the configured time resource list, the remaining bits in this MAC CE can be 0000011 (if totally used), or 0110000 (if partly used, such as the first three bits of the remaining 7 bits are used). (b) The remaining bits can be used to indicate the frequency resource ID applicable for the beam corresponding to the selected TCI state. The remaining bits can be totally used or partly used. If the remaining bits are partly used, the unused bits of Oct 1 can be directly set as reserved. (c) The remaining bits can be used to simultaneously indicate the time and frequency ID applicable for the beam corresponding to the selected TCI state. A part of remaining bits can be configured for the time resource ID. The other part of remaining bits can be configured for the frequency resource ID. For example, if there are two frequency information (e.g., carriers or BWPs) configured by the BS, one bit of these 7 bits can be used to indicate the selected frequency information, and the remaining 6 bits can be used to indicate the selected time domain information.

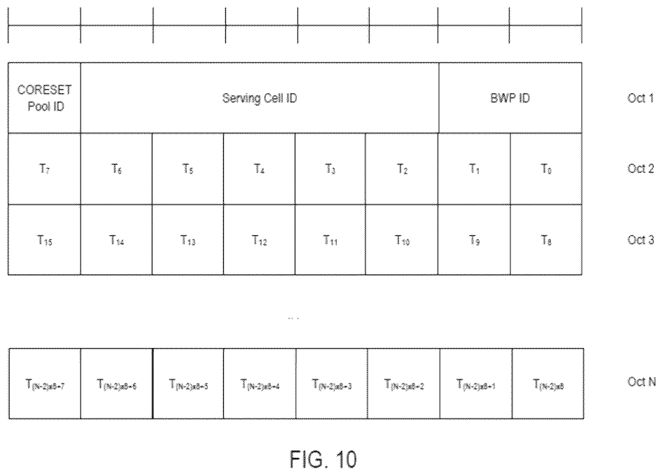

Example 2: Reusing the TCI states activation/deactivation for UE-specific physical downlink shared channel (PDSCH) MAC CE to activate/deactivate one or more TCI states for the backhaul links. The field of the TCI states activation/deactivation for UE-specific PDSCH MAC CE is shown in FIG. 10. One of bits in the Serving Cell ID field, BWP ID field, or CORESET ID field in the TCI states activation/deactivation for UE-specific PDSCH MAC CE (e.g., the first bit of Oct 1) can be acted as a flag to indicate the activated/deactivated TCI state is for the communication links or the backhaul links. If the flag is 0, it may indicate that the MAC CE is configured for the communication links. If the flag is 1, it may indicate that the MAC CE is configured for the backhaul links.

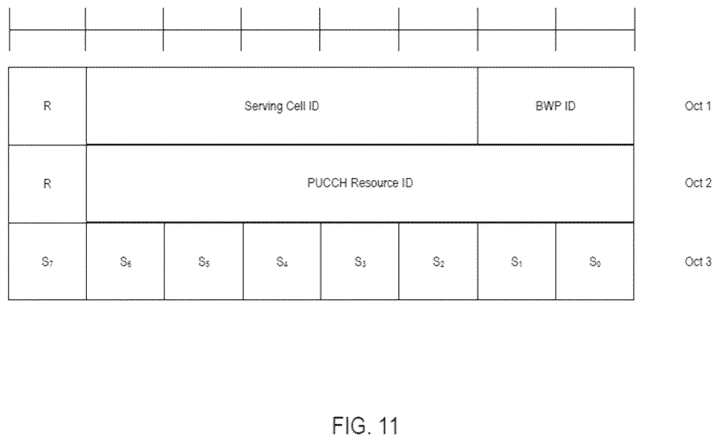

Example 3: A physical uplink control channel (PUCCH) spatial relation activation/deactivation MAC CE can be reused with some re-interpretation to indicate the spatial relation for the backhaul links. The field of the MAC CE is shown in FIG. 11. One of bits in the Serving Cell ID field, the BWP ID field, or the R field in this MAC CE can be re-interpreted as a flag to indicate this selected spatial relation is for the communication links or the backhaul links. If this flag is 0, it may indicate that the MAC CE is configured for the communication links. If this flag is 1, the remaining bits in the Oct 1 and Oct 2 can be used to indicate the corresponding time and/or frequency information applicable for this selected spatial relation.

Following methods can be considered for the use of remaining bits in the MAC CE. (a) The remaining bits can be used to indicate the time resource ID applicable for the beam corresponding to the selected spatial relation. (b) The remaining bits can be used to indicate the frequency resource ID applicable for the beam corresponding to the selected spatial relation. (c) The remaining bits can be used to simultaneously indicate the time and frequency ID applicable for the beam corresponding to the selected spatial relation. A part of remaining bits can be configured for the time resource ID, and the other part of remaining bits can be configured for the frequency resource ID.

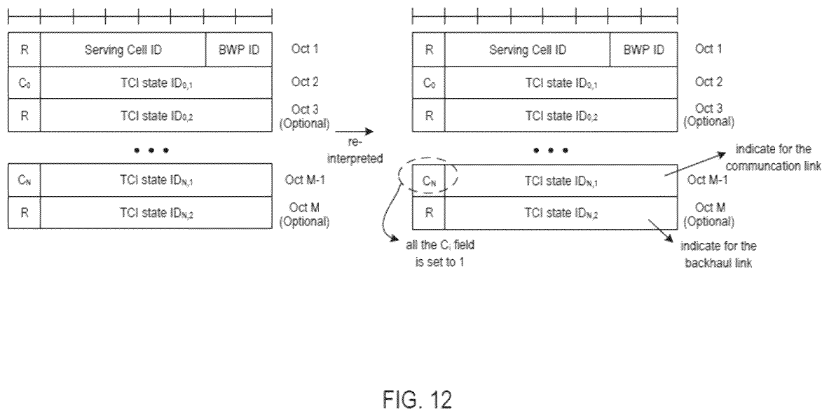

Example 4: An enhanced TCI states activation/deactivation for UE-specific PDSCH MAC CE can be reused with some refinements to activate the TCI states for the backhaul links. Following options can be considered. (a) Two TCI states can be supported in a code point of the TCI field in the DCI 1_1. In this case, the BS can simultaneously configure the TCI state for the communication link and the backhaul links in this MAC CE. For example (as shown in FIG. 12), all the Ci field can be set to 1. The corresponding first TCI state ID_{i,1} can be for the communication link. The corresponding second TCI state ID_{i,2} can be for the backhaul link. (b) One of a bit in the R field, Serving Cell ID field, or BWP ID field in the Oct 1 can be used as a flag to indicate that this MAC CE is for the communication links or the backhaul links. If this flag is 1, it may indicate that this MAC CE is configured for the backhaul link. If this flag is 0, it may indicate that this MAC CE is for the C-link.

Example 5: Unified TCI states activation/deactivation MAC CE can be re-interpreted or reused with following options. (a) One of a bit (e.g., the first bit in the Oct 1, or the first bit in the Oct 2) in the unified TCI states activation/deactivation MAC CE can be reused as a flag to indicated that this MAC CE is for the C-link or the backhaul link. If this flag is 1, it may indicate that this MAC CE is configured for the backhaul link. If this flag is 0, it may indicate that this MAC CE is for the C-link. (b) Considering that two TCI states can be supported in each TCI codepoint in this MAC CE, and the two TCI states include the DL TCI state and the UL TCI state. In such case, if the MAC CE is indicated/sent to an NCR, the two TCI states supported in each TCI codepoint can be re-interpreted as two TCI states. The two TCI states may include the TCI state for C-link and the TCI state for backhaul link when all the Pi field is set to 1.

In Step 3: A DCI to select a TCI state or spatial relation can be considered as follows. The DCI can be used to select the TCI state/spatial relation for the backhaul link with following methods. Op 3.1: A new DCI format can be defined for the NCR-Fwd to indicate the beam information. The BS may configure an extra RNTI for the NCR-Fwd in addition to the NCR-MT's RNTI. The NCR-MT may monitor the PDCCH with both RNTIs. If a DCI is scrambled by the NCR-MT's RNTI, the NCR-MT may carry out communication with the BS such as a UE with assigned time-frequency resource, MCS and other control parameters. If a DCI is scrambled by the NCR-Fwd's RNTI, the NCR-MT may decode the new DCI format for the NCR-Fwd and may control the NCR-Fwd's amplify-and-forward operation accordingly. The new DCI format for the NCR-Fwd may include one or more following content: 1) Time resource information: This field may indicate the time resource to be used by the NCR-Fwd when forwarding the signal using the indicated beam information; 2) The frequency resource information: This field may indicate the frequency resource to be used by the NCR-Fwd when forwarding the signal using the indicated beam information. The frequency resource can be associated with one of carrier, passband or BWP index; 3) The beam information: This field may indicate the beam to be used by the NCR-Fwd.

Op 3.2: A new bit can be added in the DCI to indicate the different links or the different MAC CE. For the first case, if this new bit is used to indicate the different links, the selected TCI state in the TCI field in DCI can be configured for the corresponding link. For example, when this new bit is set to 1, it may refer to the backhaul link and may indicate that the selected TCI state in the DCI is used for the beam indication for the backhaul link. When this new bit is set to 0, it may refer to the C-link, and may indicate that the selected TCI state in the DCI is used for the beam indication for the C-link. For the second case, the new bit may be used to indicate the different MAC CE. For example, if the bit 1 refers to MAC CE 1 which is used to activate the TCI states for the backhaul link, it may indicate that the TCI state indicated in the DCI is selected from the MAC CE 1 and the selected TCI state in the DCI is configured for the beam indication of backhaul link. If this new bit is set as 0, it may refer to MAC CE 2 which is configured for the C-link, and it may indicate that the TCI state in the DCI is selected from the activated TCI states in MAC CE 2 and the selected TCI state is configured for the beam indication of C-link.

Op 3.3: A new field can be added in the DCI to indicate the selected TCI state index/spatial relation for the backhaul link, such as the “Transmission configuration indication for NCR” field can be defined in the DCI 1_1, and this field is only applicable for NCR, which is absent for normal UEs.

Op 3.4: One of a bit (e.g., the first bit in the TCI field in DCI) in the DCI can be re-interpreted as a flag to indicate the different link or the different MAC CE. Regarding the first case, if this bit is used to indicate the different link, the selected TCI state in the TCI field in DCI can be configured for the corresponding link. For example, when this bit is set to 1, it may refer to the backhaul link and may indicate that the selected TCI state in the DCI is configured for the beam indication for the backhaul link. When this bit is set to 0, it may refer to the C-link and may indicate that the selected TCI state in the DCI is configured for the beam indication for the C-link. Regarding the second case, the bit can be configured for the index of different MAC CE. For example, if the bit 1 refers to the MAC CE 1 which is used to activate the TCI states for the backhaul link, it may indicate that the TCI state indicated in the DCI is selected from the MAC CE1 and the selected TCI state in DCI is configured for the beam indication of backhaul link. If this bit is set as 0, it may refer to the MAC CE 2 which is configured for the C-link, and may indicates that the TCI state in the DCI is selected from the activated TCI states in MAC CE 2 and the selected TCI state is configured for the beam indication of C-link.

Implementation Example 3: BS can directly indicate a number of TCI states that are applicable for the backhaul link to NCR

In a TCI framework, a MAC CE can be used to activate a sub-set of TCI states from the TCI state configuration in a RRC signaling. A DCI signaling can be used to select a TCI state from the sub-set of MAC CE. In such case, the BS can directly indicate the number of TCI states that are applicable for the backhaul link to the NCR. When the NCR receives the selected TCI state indicated by the DCI, the NCR may check whether the selected TCI state ID belongs to the applicable TCI states for the backhaul link. If the selected TCI state ID is in the applicable TCI states for the backhaul link, the selected TCI state can also be configured for the beam indication for the backhaul link. If the selected TCI state ID does not belong to the applicable TCI states for the backhaul link, the selected TCI state can only be configured for the beam indication for C-link. For example, there can be 8 TCI states activated by the MAC CE signaling, and the BS may indicate to the NCR that only the first 4 TCI states activated in the MAC CE that can be used by the backhaul link. In this case, if the TCI field in the DCI is 2, it may indicate that this TCI state can be simultaneously configured for the beam indication of C-link and backhaul link. If the TCI field in the DCI is 5, it may indicate that the selected TCI state can only be applicable for the beam indication of C-link.

### Implementation Example 4: Capability Information of NCR may be Acknowledged by BS

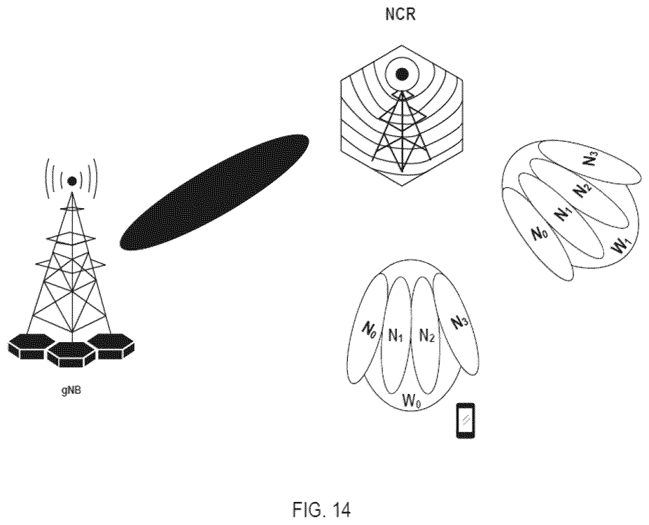

Considering that there may exist different types of beams (e.g., the wider beam and/or the narrow beam) for an access link of NCR. The relationships between the different types of beams may be reported by the NCR to the BS or directly configured to the BS by operations, administration and maintenance (OAM). For example, as shown in FIG. 14, there can be two wide beams (W0˜W1) on the access link and each wide beam include 4 narrow beams (N0˜N3). In such case, in addition to reporting a number of NCR's beams supported on the access link and a width of NCR's beams supported on the access link, the relationship between the different type/width beams may be also sent to the BS by the NCR or by the OAM.

The number of beams for simultaneous operation may be reported by the NCR to the BS or directly configured to the BS by the OAM. When one or more beams are indicated to the NCR, following operations with the indicated beams can be considered. (1) If an associated time applicable for each beam is indicated to the NCR, the one or more indicated beams may be used one by one by the NCR to forward the signal in the corresponding time. (2) If only one applicable time is indicated to the NCR, it may indicate that the plurality of indicated beams is used at a same time, following options can be considered. Op 1: If frequency resource information applicable for each beam is indicated to the NCR, the corresponding beam may be used in the corresponding frequency resource at a same time. Op 2: If no frequency resource is indicated to the NCR for the indicated beams or only one frequency resource that is applicable for all beams is indicated to the NCR, it may implicitly indicate that the one or more indicated beams may be used at different RF channel or different panels.

Moreover, considering that the NCR may have multiple panels, the number of panels of NCR and the number of panels for simultaneous operation of NCR may be also reported by the NCR to the BS or directly configure by the OAM to the BS. The number of frequency resource supported on NCR and the number of frequency resource for simultaneous operation of NCR may be reported by the NCR to the BS or directly configure by the OAM to the BS. The frequency resource can be the carrier, the passband or the BWP.

It should be understood that one or more features from the above implementation examples are not exclusive to the specific implementation examples, but can be combined in any manner (e.g., in any priority and/or order, concurrently or otherwise).

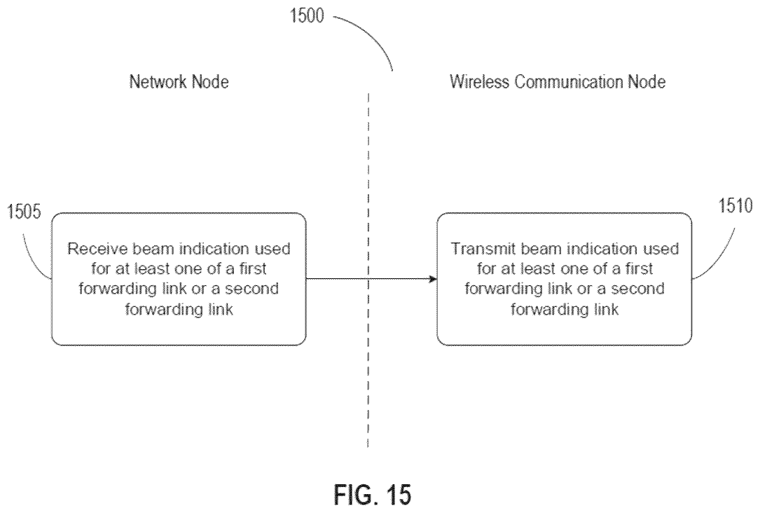

FIG. 15 illustrates a flow diagram for identifying beams for forwarding links, in accordance with an embodiment of the present disclosure. The method 1500 may be implemented using any one or more of the components and devices detailed herein in conjunction with FIGS. 1-2. In overview, the method 1500 may be performed by a network node, in some embodiments. Additional, fewer, or different operations may be performed in the method 1500 depending on the embodiment. At least one aspect of the operations is directed to a system, method, apparatus, or a computer-readable medium.

At least one aspect is directed to a system, method, apparatus, or a computer-readable medium of the following. A network node (e.g., a secondary node (SN)) may receive beam indication used for at least one of a first forwarding link or a second forwarding link from a wireless communication node (e.g., a base station (BS)). The first forwarding link (e.g., an access link) can be between a wireless communication device and the network node. The second forwarding link (e.g., a backhaul link) can be between the wireless communication node and the network node. The beam indication may include one or a plurality of beams.

In some embodiments, the wireless communication node may receive the capability information of network node from the network node or an operations administration and maintenance (OAM) unit. The capability information may include at least one of the following: relationships between different types of beams of the network node; a number of beams for simultaneous operation; a number of panels of the network node; a number of panels for simultaneous operation; a number of frequency resource supported on the network node; or a number of frequency resource for simultaneous operation.

In some embodiments, the network node may receive first beam indication including a list of beam patterns from the wireless communication node. Each beam pattern may include one or a plurality of ordered beams to be used one by one and may have a beam pattern index for the list. The network node may receive second beam indication including one or more beam pattern indices from the wireless communication node. The beam can be associated with one of a beam index, a source Reference Signal (RS) identification, or a Transmission Configuration Indicator (TCI) state identification.

In some embodiments, the indices or identities of beams on the first forwarding link of the different network node can be numbered using different numbering methods. The numbering methods can be associated with a capability of the network node.

A signaling of beam indication can be indicated via at least one of a Radio Resource Control (RRC) signaling, a medium access control control element (MAC CE) signaling, or a Downlink Control Information (DCI) signaling.

In some embodiments, the network node may receive information indication associated with the beam indication from the wireless communication node. The information indication may include at least one of: respective time resource information associated with the one or plurality of beams; respective frequency resource information associated with the one or plurality of beams; or respective panel information associated with the one or plurality of beams. The frequency resource information can be associated with one of a carrier index, a passband index, or a Bandwidth Part (BWP) index. The respective frequency resource information may include a sequence of indices for frequency resources. Each of the frequency resource can be associated with a beam indicated in the beam indication.

In some embodiments, the respective frequency resource information may include a sequence of index for frequency resource. Each of the frequency resource can be associated with the plurality of beams indicated in the beam indication. The respective frequency resource information may include a single index for a single frequency resource. The single frequency resource can be associated with all beams indicated in the beam indication. The respective panel information may include a sequence of index for panel information. Each of panel information can be associated with a beam indicated in the beam indication. The respective panel information may include a sequence of index for panel information. Each of panel information can be associated with the plurality of beams indicated in the beam indication. The respective panel information may include a single index for panel information. The single panel information can be associated with all beams indicated in the beam indication. The signaling of the information indication can be at least one of a Radio Resource Control (RRC) signaling, a medium access control control element (MAC CE) signaling, or a Downlink Control Information (DCI) signaling.

In some embodiments, the DCI may have a first DCI format and a second DCI format. The first DCI can be scrambled with a first Radio Network Temporary Identifier (RNTI). The first DCI can be used for the control link between the network node and the wireless communication node. The second DCI can be scrambled with a second Radio Network Temporary Identifier (RNTI). The second DCI can be used for the first forwarding link.

In some embodiments, one of existing bits in a MAC CE signaling can be configured to indicate activated TCI states in the MAC CE that are configured for the second forwarding link or a control link between the network node and the wireless communication node. A new bit in a MAC CE signaling can be configured to indicate activated TCI states in the MAC CE that are configured for the second forwarding link or a control link between the network node and the wireless communication node. One or a plurality of bits in the MAC CE signaling can be used to indicate time domain information associated with the activated TCI states. One or a plurality of bits in the MAC CE signaling can be used to indicate frequency domain information associated with the activated TCI states. One or a plurality of bits in the MAC CE signaling can be used to simultaneously indicate time domain information and frequency domain information associated with the activated TCI states. A first part of bits can be used to indicate the time domain information and a second part of bits can be used to indicate the frequency domain information.

In some embodiments, a pair of TCI states can be activated in a MAC CE signaling. A first TCI state in the activated pair of TCI states can be used for the beam indication of second forwarding link. A second TCI state in the activated pair of TCI states can be used for the beam indication of a control link between the network node and the wireless communication node. One of existing bits in a DCI signaling can be used to indicate selected TCI states that are used for the second forwarding link or a control link between the network node and the wireless communication node.

In some embodiments, one of existing bits in a DCI signaling can be used to indicate one or more TCI states selected from a first MAC CE signaling or a second MAC CE signaling. The first MAC CE signaling can be used to activate the one or more TCI states for the second forwarding link. The second MAC CE signaling can be used to activate the one or more TCI states for a control link between the network node and wireless communication node. A new bit in a DCI signaling can be used to indicate selected TCI states that are used for the second forwarding link or a control link between the network node and the wireless communication node. A new bit in a DCI signaling can be used to indicate one or more TCI states selected from a first set of TCI states activated by a first MAC CE signaling or from a second set of TCI states activated by a second MAC CE signaling. The first MAC CE signaling can be used to activate the one or more TCI states for the second forwarding link. The second MAC CE signaling can be used to activate the one or more TCI states for a control link between the network node and wireless communication node. In some embodiments, the network node may receive a number of TCI states that are used for the second forwarding link from the wireless communication node.

In some embodiments, a wireless communication node may transmit beam indication used for at least one of a first forwarding link or a second forwarding link to a network node. The first forwarding link can be between a wireless communication device and the network node. The second forwarding link can be between the wireless communication node and the network node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
receiving, by a network node from a wireless communication node, beam indication used for at least one of a first forwarding link or a second forwarding link:
wherein the first forwarding link is between a wireless communication device and the network node, and the second forwarding link is between the wireless communication node and the network node.

2. The wireless communication method of claim 1, further comprising receiving, by the wireless communication node from the network node or an operations administration and maintenance (OAM) unit, the capability information of network node, wherein the capability information includes at least one of the following:
relationships between different types of beams of the network node:
a number of beams for simultaneous operation:
a number of panels of the network node;
a number of panels for simultaneous operation:
a number of frequency resource supported on the network node; or
a number of frequency resource for simultaneous operation.

3. The wireless communication method of claim 1, wherein the beam indication includes one or a plurality of beams.

4. The wireless communication method of claim 1, further comprising,
receiving first beam indication including a list of beam patterns, wherein each beam pattern includes one or a plurality of ordered beams to be used one by one and has a beam pattern index for the list; and
receiving second beam indication including one or more beam pattern indices.

5. The wireless communication method of claim 3, wherein the beam is associated with one of a beam index, a source Reference Signal (RS) identification, or a Transmission Configuration Indicator (TCI) state identification.

6. The wireless communication method of claim 1, wherein the indices or identities of beams on the first forwarding link of the different network node are numbered using different numbering methods.

7. The wireless communication method of claim 6, wherein the numbering methods are associated with a capability of the network node.

8. The wireless communication method of claim 1, wherein a signaling of beam indication is indicated via at least one of a Radio Resource Control (RRC) signaling, a medium access control control element (MAC CE) signaling, or a Downlink Control Information (DCI) signaling.

9. The wireless communication method of claim 1, further comprising:
receiving, by the network node from the wireless communication node, information indication associated with the beam indication, the information indication includes at least one of:
respective time resource information associated with the one or plurality of beams;
respective frequency resource information associated with the one or plurality of beams; or
respective panel information associated with the one or plurality of beams.

10. The wireless communication method of claim 2, wherein the frequency resource information is associated with one of a carrier index, a passband index, or a Bandwidth Part (BWP) index.

11. The wireless communication method of claim 9, wherein the respective frequency resource information includes a sequence of indices for frequency resources, and each of the frequency resource is associated with a beam indicated in the beam indication.

12. The wireless communication method of claim 9, wherein the respective frequency resource information includes a sequence of index for frequency resource, and each of the frequency resource is associated with the plurality of beams indicated in the beam indication.

13. The wireless communication method of claim 9, wherein the respective frequency resource information includes a single index for a single frequency resource, and the single frequency resource is associated with all beams indicated in the beam indication.

14. The wireless communication method of claim 9, wherein the respective panel information includes a sequence of index for panel information, and each of panel information is associated with a beam indicated in the beam indication.

15. The wireless communication method of claim 9, wherein the respective panel information includes a sequence of index for panel information, and each of panel information is associated with the plurality of beams indicated in the beam indication.

16. The wireless communication method of claim 9, wherein the respective panel information includes a single index for panel information, and the single panel information is associated with all beams indicated in the beam indication.

17. The wireless communication method of claim 9, wherein the signaling of the information indication is at least one of a Radio Resource Control (RRC) signaling, a medium access control control element (MAC CE) signaling, or a Downlink Control Information (DCI) signaling.

18. A wireless communication method, comprising:
transmitting, by a wireless communication node to a network node, beam indication used for at least one of a first forwarding link or a second forwarding link;
wherein the first forwarding link is between a wireless communication device and the network node, and the second forwarding link is between the wireless communication node and the network node.

19. A wireless communication node, comprising:
at least one processor configured to:
transmit, via a transmitter to a network node, beam indication used for at least one of a first forwarding link or a second forwarding link;
wherein the first forwarding link is between a wireless communication device and the network node, and the second forwarding link is between the wireless communication node and the network node.

20. A network node, comprising:
at least one processor configured to:
receive, via a receiver from a wireless communication node, beam indication used for at least one of a first forwarding link or a second forwarding link;
wherein the first forwarding link is between a wireless communication device and the network node, and the second forwarding link is between the wireless communication node and the network node.
